(19) United States
(12) Patent Application Publication
(10) Pub. No.: US 2023/0316661 A1
(43) Pub. Date: Oct. 5, 2023

(54) METHOD FOR PREVENTING THE VIEWING OF DATA REGARDED AS CONFIDENTIAL IN A SHARED AUGMENTED REALITY ENVIRONMENT AND SYSTEM OF PROTECTION

(71) Applicant: AMBIT MICROSYSTEMS (SHANGHAI) LTD., Shanghai (CN)

(72) Inventor: Yu-Hu YAN, New Taipei (TW)

(21) Appl. No.: 17/706,819

(22) Filed: Mar. 29, 2022

(51) Int. Cl. G06T 19/00; G06F 3/03

(52) U.S. Cl. CPC G06T 19/006; G06F 3/03

(57) ABSTRACT

A system and method for protecting information regarded as confidential, from remote connections in an augmented reality (AR) environment, by hiding or obscuring objects or virtual objects in the viewed AR environment. A server applies the method, the system includes the server, a local AR device, and one or more remote users using remote devices. The server, acting upon the authority level associated with each user ID, provides a spatial model and a mask model, the mask model hiding and obscuring a part of the spatial model. An image captured by the AR device is shared with a remote user on his remote device, but the image which is so viewable includes a mask model over the actual image (image in reality). The image or images in reality are obtained by a camera unit of the AR device and the mask model is provided by the server.

### FIELD

The disclosure relates to augmented reality technology, in particular to a confidential protected method and a system for remote assistant in augmented reality environment.

### BACKGROUND

A remote assistant in augmented reality session can share an on-site scene, but some confidential information can also be shared, this is not optimal.

### BRIEF DESCRIPTION OF THE DRAWINGS

Implementations of the present technology will now be described, by way of embodiment, with reference to the attached figures, wherein:

FIG. 1 shows system architecture of augmented reality (AR) session in the disclosure.

FIG. 2 is a flowchart of a method applied in a server for protecting confidential information from remote assistant in AR environment, according to an embodiment of disclosure.

FIG. 3 is a flowchart of an AR device used in the method according to an embodiment of disclosure.

FIG. 4A shows part of a scene of the local device in AR environment according to an embodiment of disclosure.

FIG. 4B shows part of a scene viewed by the remote device in AR environment according to an embodiment of disclosure.

FIG. 5 is a functional block diagram of the AR device in AR environment according to an embodiment of disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. The term “comprising,” when utilized, is “including, but not necessarily limited to”; it specifically indicates open-ended inclusion or membership in the so-described combination, group, series, and the like. References to “an” or “one” embodiment in this disclosure are not necessarily to the same embodiment, and such references mean “at least one.”.

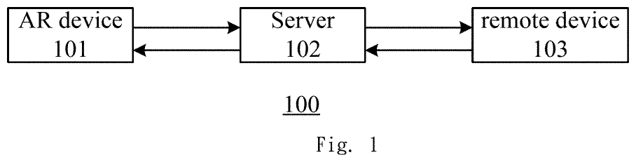

FIG. 1 shows elements of a system for protecting information regarded as confidential from being viewed by a remote assistant sharing a video call in an augmented reality (AR) environment. The system (system 100) includes a local device (AR device 101), a server 102, and a remote device 103. The AR device 101 (of local user) and the remote device 103 (remote user) communicate in the AR environment in real time within virtual objects. A mask model is provided by the server 102 to mask part of a viewed scene to avoid viewing of confidential information by the remote assistant during the video call. The application environment allows scan by a camera or is constructed with indoor/outdoor positioning technology (e.g. WI-FI, BLUETOOTH, Global Positioning System) in a pre-operation of constructing the system 100. A spatial model of the application environment is established and be stored in the server 102. The server 102 provides the spatial model. The AR device 101 obtains a spatial relationship of the application environment according to the spatial model. The AR device 101 obtains a spatial relationship of a virtual object (e.g. the mask model, an object marked by local user) of the AR environment according to the spatial model. The AR device 101 and the remote device 103 can each log in with a user ID. The server 102 provides the mask model corresponding to a permission according to authority of the user ID and can mask part of the spatial model through the mask model.

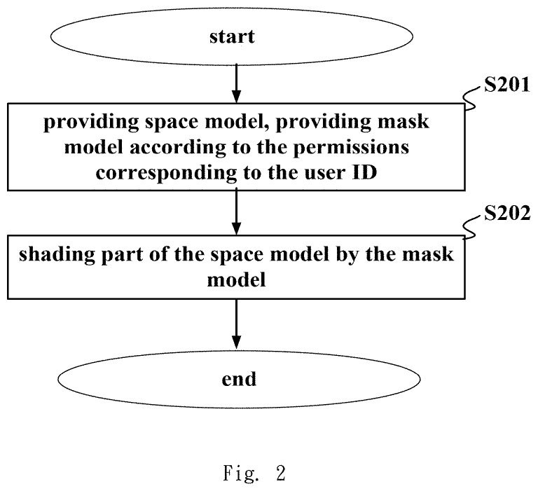

FIG. 2 is a flowchart of a method applied in server for the system 100 according to an embodiment disclosed.

As shown in FIG. 2, in step S201, the server 102 provides the spatial model and provides mask model according to the permissions associated with user IDs. The server 102 provides the spatial model. The AR device 101 obtains the spatial relationship of the application environment according to the spatial model. The AR device 101 obtains the spatial relationship of the virtual object of the AR environment according to the spatial model.

In step S202, part of the spatial model can be shaded by the mask model. The AR device 101 and the remote device 103 each log in with their respective IDs. The server 102 provides the mask model corresponding to the ID permissions and thereby masks part of the spatial model.

Out of all users taking part, one or more users may not have permission to access a specific area when multiple users participate in the same video call. The server 102 provides a spatial model that complies with all user rights, and provides a mask model to mask information from users not permitted to see information beyond their rights. For the example, the spatial model can distinguish five areas: area A, area B, area C, area D and area E. Users can be divided into three classes of user ID, general employee, manufacturer, and customer. General employee can access area A, area B, area C, and area D, but not area E. Manufacturer can access area A and area B, the mask model obscures area C, area D, and area E. Customers can access area A and area C, the mask model hides area B, area D, and area E from the customer.

The server 102 provides a mask model corresponding to the lowest authority or permission when multiple users are joined into the same video call at the same time. For example, area B, area D, area E are shadowed by the mask model if the server 102 determines that the participants of a first meeting are general employees or customers, according to their user IDs. Area B, area C, area D, area E are shadowed by mask model when the server 102 determines that the participants of a second meeting include general employees, manufacturer, and customers, according to their user IDs.

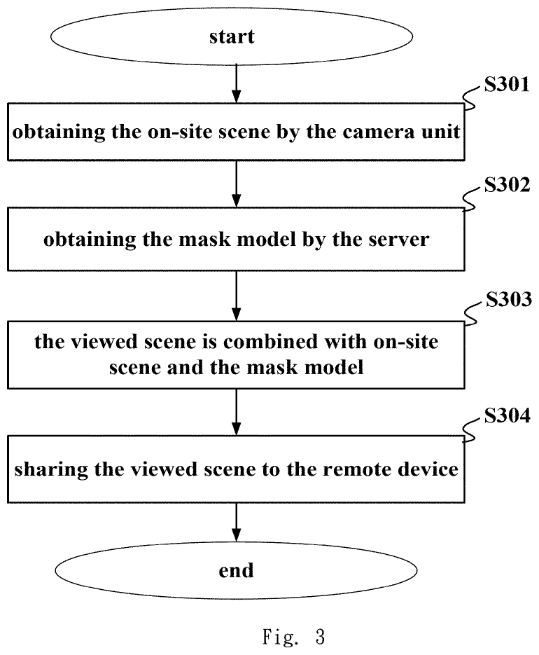

FIG. 3 is a flowchart of a method in which an AR device operates according to an embodiment of disclosure.

In step S301, the on-site scene is obtained through a camera unit.

In step S302, the mask model is obtained from the server.

In step S303, the scene which is viewed is combined with the on-site scene and the mask model.

In step S304, the viewed scene is shared to the remote device.

The AR device obtains the on-site scene through the camera unit. A location of the AR device and the mask model in the AR environment are obtained from the server. The mask model is a virtual object in the AR environment. Parameters of the object include a location of the mask model, a size of the mask model, and a shape of the mask model. The viewed scene is combined with the on-site scene and the mask model which shows in a display unit in the AR device. The viewed scene is shared to the remote device. The confidential areas are covered and obscured by the mask model, thus confidential information is not included in data of the scene which is shared to the remote device.

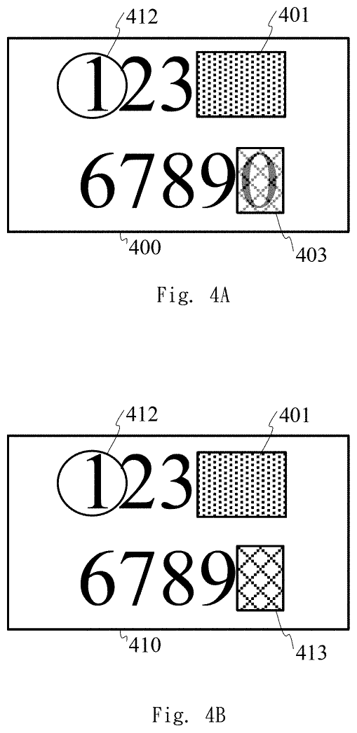

FIG. 4A is a viewed scene of the local device in the AR environment according to an embodiment of disclosure.

As shown in FIG. 4A, the local device is the AR device. The AR device shares a first viewed scene 400 to the remote devices, the first viewed scene 400 is what is seen by the local AR device. The first viewed scene 400 includes a mask model 401, a first object 412, and a second object 403. The mask model 401 is obtained from the server. The first object 412 is marked by the remote device. The second object 403 is marked by the user of the local AR device.

FIG. 4B is a viewed scene of the remote device in the AR environment according to an embodiment of disclosure.

As shown in FIG. 4B, a second viewed scene 410 of the remote device is shared from the AR device. The second viewed scene 410 includes the mask model 401, the first object 412, and a second object 413. The first object 412 is marked by the remote device when displayed in the first scene 400. The second object 403 can be marked by a user interface unit of the AR device. The first object 412 and the second object 403 are not limited in any way, and can be in any kind of forms, such as circles, handwritten notes, any other object, etc.

For the examples as shown in FIG. 4A and FIG. 4B, the first object 412 is marked by the remote device to show a circled number “1”. The number “1” is circled by the first object 412 in the viewed scene of the local device. Number “0” obscures the second object 403 in the viewed scene of the local device. Transparency of the second object 403 can be set to indicate to the user that an object (the object obscured by the “0”) is masked when displayed in the first scene 400 of the AR device. The second object 413 be set as non-transparent when viewed on the remote device. Thus, even the number “0” is hidden from view in the scene which is viewed on the remote device.

The user interface unit of the AR device and of the remote device each include a keyboard, a mouse, a touch panel, remote controller, voice control unit, and a gesture recognition unit, but not limited to these.

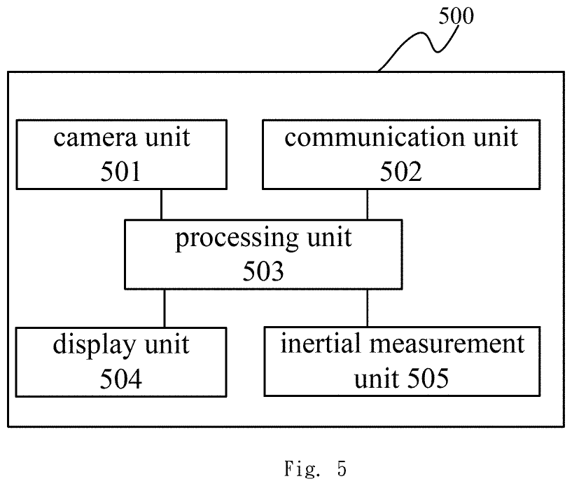

FIG. 5 is a functional block diagram of the AR device in AR environment according to an embodiment of disclosure. As shown in FIG. 5, the AR device includes a camera unit 501, a communication unit 502, a processing unit 503, a display unit 504, and an inertial measurement unit 505.

The camera unit 501 captures image of scene on-site. The communication unit 502 communicates with the server. The AR device 500 obtains the mask model from the server through the communication unit 502. Spatial information of the first object is transmitted to the server when the first object is marked by the remote device. The spatial information of the first object is a distance, an orientation, or an angle between the AR device and the first object. The spatial information of the first object is obtained from the server through the communication unit and is displayed in the display unit 504. The AR device 500 shares the viewed scene with the remote device through the communication unit 502. The viewed scene includes the on-site scene, but also the mask model and the second object which were created by the AR device.

The processing unit 503 combines the on-site scene and the mask model as the scene which is viewable in the display unit 504. The processing unit 503 processes gesture recognition according to the scene which is captured by the camera unit 501. The second object is controlled according to the gestures of the user. For example, a state of the second object in the viewed scene can be controlled according to gestures, such as add to, move to (a position), and delete, etc.

The inertial measurement unit 505 obtains parameters of any movement. The parameters of moving includes a moving direction, a moving distance, a moving height, and a moving angle. The processing unit 503 adjusts the spatial relationship of the mask model, and of the first object and the second object according to the parameters of moving. 3D viewing and authenticity of user experience of the virtual objects in AR environment are provided or are improved.

The embodiments shown and described above are only examples. Therefore, many details of such art are neither shown nor described. Even though numerous characteristics and advantages of the technology have been set forth in the foregoing description, together with details of the structure and function of the disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

1. A confidential protected system configured for a remote assistant in an augmented reality (AR) environment, the confidential protected system comprising:
a server configured to provide a spatial model with a mask model according to a user identification (ID) having a corresponding permission, wherein the mask model is configured to shaded the spatial model, and obtain the spatial relationship of the mask model in the space model, wherein the spatial model corresponds to real environment generated; and
a AR device configured to obtain the mask model and the spatial relationship of the mask model in the space model from the server, wherein according to the spatial relationship of the mask model in the space model, a part of the on-site scene are shaded correspondingly through the mask model, and shares a viewed scene to a remote device, the AR device is further configured to display a first object to shade part of the on-site scene, wherein the first object is placed based on the spatial relationship sent by the remote device, and the viewed scene comprises an on-site scene and the mask model, the on-site scene is the real environment obtained by a camera unit of the AR device;
wherein, the user identification (ID) includes a first user identification and a second user identification, the mask model includes the first mask model and the second mask model, when the user identification is the first user identification code, the first mask is provided to cover the first area in the space model, when the user identification code is the second user identification code, a second mask model is provided to mask the second area in the space model.

2. The confidential protected system in claim 1, wherein the AR device further comprises an inertial measurement unit (IMU) configured to obtain a moving direction, a moving distance, a moving height and a moving angle.

3. The confidential protected system in claim 2, wherein the AR device adjusts spatial relations between the mask model, the first object in the on-site scene according to the moving direction, the moving distance, the moving height and the moving angle of the AR device, the AR device is further configured to convert the moving direction, the moving distance, the moving height and the moving angle into spatial relationship in the space model.

4. (canceled)

5. The confidential protected system in claim 3, wherein the AR device further comprises a user interface unit, wherein the AR device further displays a second object to shade part of the on-site scene, wherein the second object is placed based on the spatial relationship sent by the user interface unit, and the second object in the on-site scene object according to the moving direction, the moving distance, the moving height and the moving angle of the AR device.

6. A confidential protected method of a remote assistant applicable in an augmented reality (AR) environment, the confidential protected method comprising:
providing a spatial model, a mask model according to a user identification (ID) with a corresponding permission by a server, wherein the mask model is configured to shade the spatial model, and obtaining the spatial relationship of the mask model in the space model, wherein the spatial model corresponds to real environment generated;
obtaining an on-site scene by a camera unit of a AR device;
obtaining the mask model and the spatial relationship of the mask model in the space model from the server, and according to the spatial relationship of the mask model in the space model, a part of the on-site scene are shaded correspondingly through the mask model;
sharing a viewed scene of the AR device to a remote device; and
displaying, by the AR device, a first object to shade a part of the on-site scene, wherein the first object is placed based on the spatial relationship sent by the remote device, wherein the viewed scene comprises the on-site scene and the mask model, the on-site scene is the real environment obtained by a camera unit of the AR device;
wherein, the user identification (ID) includes a first user identification and a second user identification, the mask model includes the first mask model and the second mask model, and the confidential protected method further comprises:
when the user identification is the first user identification code, providing the first mask that covers the first area in the space model; and
when the user identification code is the second user identification code, providing a second mask model that masks the second area in the space model.

7. The confidential protected method in claim 6, wherein the AR device further comprises an inertial measurement unit (IMU) configured to obtain a moving direction, a moving distance, a moving height and a moving angle.

8. The confidential protected method in claim 7, wherein the AR device adjust spatial relations between the mask model, the first object in the on-site scene according to the moving direction, the moving distance, the moving height and the moving angle of the AR device, and the confidential protected method further comprises:
converting the moving direction, the moving distance, the moving height and the moving angle into spatial relationship in the space model by the AR device.

9. (canceled)

10. The confidential protected method in claim 8, wherein the AR device further comprises a user interface unit, and the confidential protected method further comprises:
displaying, by the AR device, a second object which shades a part of the on-site scene, wherein the second object is placed based on the spatial relationship sent by the user interface unit, and the second object in the on-site scene object according to the moving direction, the moving distance, the moving height and the moving angle of the AR device.
